(19) United States
(12) Patent Application Publication
(10) Pub. No.: US 2015/0281440 A1
(43) Pub. Date: Oct. 1, 2015

(54) INTERACTIVE VOICE RESPONSE SYSTEM LINKED TO A CALENDARING AND AVAILABILITY SYSTEM

(71) Applicant: TimeTrade Systems, Inc., Tewksbury, MA (US)

(72) Inventors: Brian Kelly, Tewksbury, MA (US); Gary Ambrosino, Tewksbury, MA (US)

(21) Appl. No.: 14/594,525

(22) Filed: Jan. 12, 2015

Related U.S. Application Data
(60) Provisional application No. 61/972,505, filed on Mar. 31, 2014.

(51) Int. Cl. H04M 3/493

(52) U.S. Cl. CPC H04M 3/493

(57) ABSTRACT

An Interactive Voice Response (IVR) system is provided that is integrated with a calendaring and availability system. A telephone caller calls to book a future appointment with the entity or organization that was originally called but is unavailable at the time of the call. This invention can be used to provide call center-like capabilities in the context of appointment scheduling but without the overhead cost of staffing a call center with human operatives.

### CROSS REFERENCE TO RELATED APPLICATION

This application claims priority to U.S. Provisional Application No. 61/972,505, filed Mar. 31, 2014, the entirety of which is incorporated herein by reference.

### TECHNICAL FIELD

The present disclosure relates to interactive voice response systems and calendaring systems.

### BACKGROUND

Often a person calls a service provider to schedule (book) an appointment, but the service provider is unavailable at the time of the call. This can be frustrating for the calling party, because he/she can leave a voicemail message, but is left feeling that the service provider will not act on the voicemail message.

### SUMMARY

The invention presented herein pertains to an Interactive Voice Response (IVR) system that is integrated with a calendaring and availability system. The invention allows a telephone caller to book a future appointment with the entity or organization that was originally called but is unavailable at the time of the call. This invention can be used to provide call center-like capabilities in the context of appointment scheduling but without the overhead cost of staffing a call center with human operatives.

### BRIEF DESCRIPTION OF THE DRAWINGS

FIG. 1 shows the components of the system and how they are connected, according to an example embodiment.

FIG. 2 shows the flow of a conversation between a human caller and the IVR system, according to an example embodiment.

FIG. 3 illustrates a technique for reserving/designating certain time slots to remain available for service appointments, according to an example embodiment.

FIG. 4 illustrates a flow chart of operations performed according to an example embodiment.

FIG. 5 shows an example block diagram of the IVR system, according to an example embodiment.

### DETAILED DESCRIPTION OF EXAMPLE EMBODIMENTS

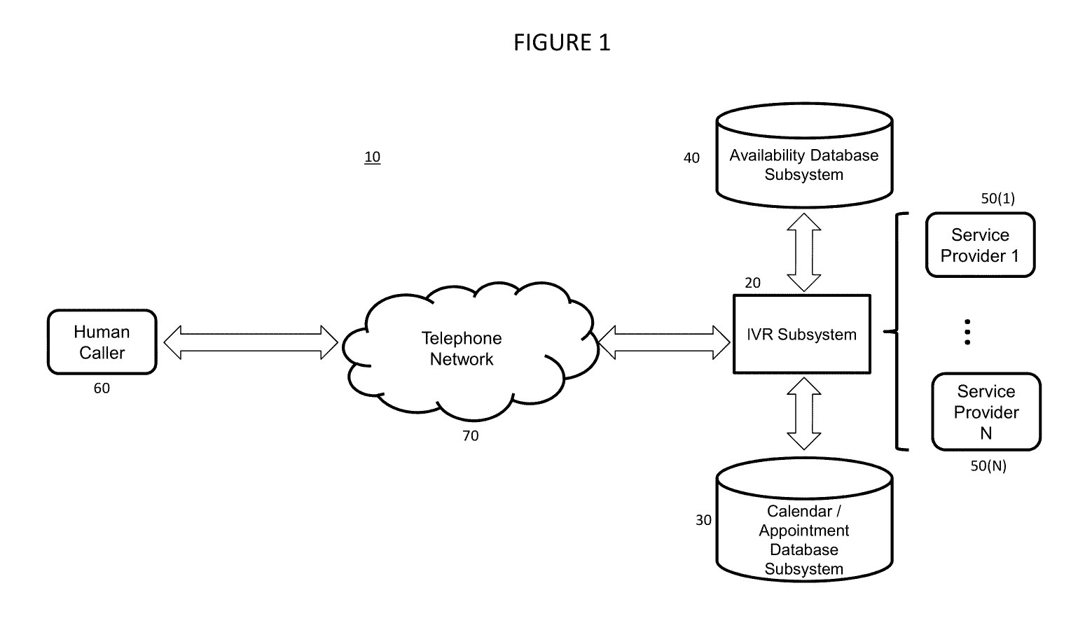

Reference is made to FIGS. 1-3 for purposes of the description provided below.

The system and method presented brings together the technologies of IVR and calendaring to provide a convenient experience to telephone callers trying to book appointments with service providers. Reference is first made to FIG. 1. FIG. 1 illustrates a system 10 that includes an IVR subsystem 20, a calendar/appointment database subsystem 30, an availability database subsystem 40, and one or more service providers 50(1)-50(N). A human caller (using any phone device, wired-landline, wireless cellular phone, etc.) is shown at reference numeral 60, and can place a call that is connected by the telephone network 70 to the IVR system 20. The service providers 50(1)-50(N) may be any entity for which a person needs to make an appointment, such as a doctor's office, car maintenance service company, technology service company, etc.

The system 10 is capable of handling incoming telephone calls and parsing voice audio from the callers, and then taking commands obtained from the parsed audio, and relaying them to the calendar appointment/database subsystem 30 and the availability database subsystem 40 that stores information indicating when appointments can be booked. The IVR Subsystem 20 provides a voice-based interaction to ensure the caller 60 can schedule, reschedule or cancel their appointments with the service provider using the system 10. It should be understood that the functions of the availability database subsystem 40 and the calendar/appointment database subsystem 30 may be performed by one computing subsystem or separate computing subsystems. Thus, the term “calendar subsystem” may refer to the combination of the availability database subsystem calendar appointment/database subsystem 30 and the availability database subsystem 40. Thus, the calendar subsystem effectively stores and manages appointment data for a plurality of service providers 50(1)-50(N).

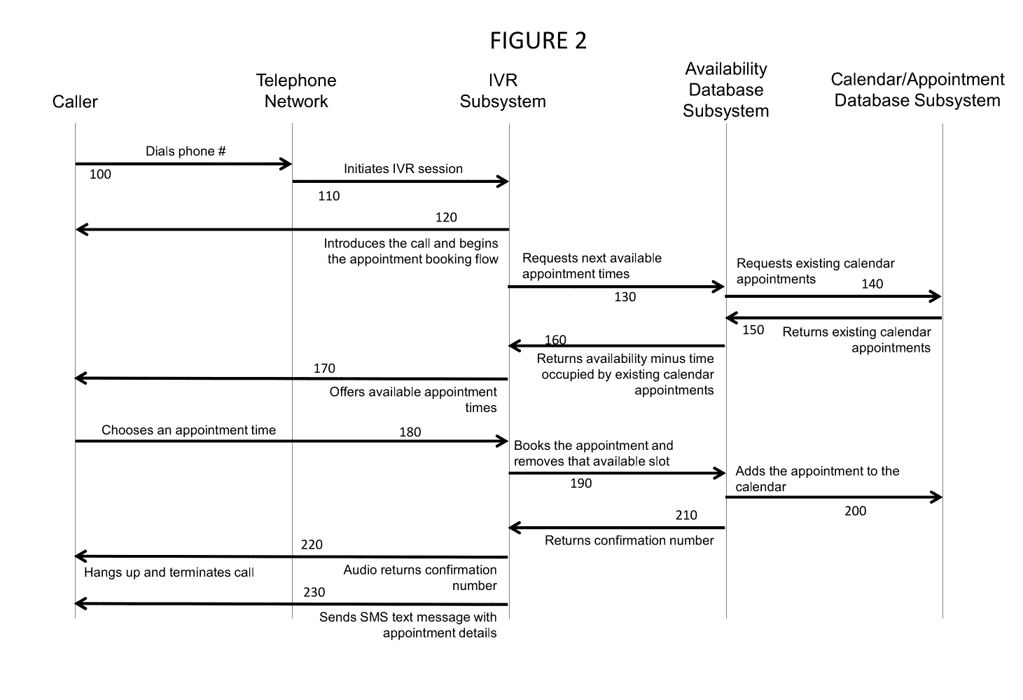

Reference is now made to FIG. 2, with continued reference to FIG. 1. A typical interaction with the system will start with a caller telephoning the service provider's listed phone number as shown at reference numerals 100 and 110. Once connected, the IVR subsystem 20 uses IVR technology to ascertain from voice audio from caller the desired location for the appointment with the service provider (if the service provider has multiple locations where it can service the appointment), as shown at reference numeral 120. Thus, at 120, the IVR system plays out audio to the caller that prompts the caller to convey information about the about the appointment that the caller is seeking to make. If the desired appointment is “virtual” (that is, phone-based or perhaps via Web Conference) then it may not be necessary to obtain location information for the appointment.

In an alternative form, there are some applications where it is not necessary to play out audio to the caller in order to prompt the caller to convey information about the appointment that the caller is seeking to make. Instead, an identifier of the caller, derived from the received call from the caller (such as a caller line identifier (Caller ID)), may be used to automatically recognize/identify the caller and if the caller has registered with the system or made appointments with the system previously, then the type of appointment that the caller is seeking to make may be determined from past behavior/prior appointment activity of the caller. In this case, available appointment times for the caller can be requested without having to prompt the caller to convey information about the appointment that the caller is seeking to make. Thus, information about the appointment the caller is seeking to make may be determined simply based on reception of the call from the caller (e.g., through a Caller ID).

At 130, the IVR subsystem 20 requests next available appointment times from the availability database subsystem 40 based on the information received from the caller (or automatically derived from reception of the call from the caller), such as information about the location of the appointment, type of appointment, etc. The availability database subsystem 40 will in turn request existing calendar appointments from the calendar/appointment database subsystem 30. At 150, the calendar/appointment database subsystem 30 returns existing calendar appointments to the availability database subsystem 40. At 160, the availability database subsystem will return to the IVR subsystem 20 availability minus time occupied by existing calendar appointments.

At 170, the IVR subsystem 20 plays out audio announcing to the caller the available appointment times. The audio played out at 170 also prompts the caller to select one of those available times. The available appointment times presented to the caller will be accurate because the system is capable of querying the calendar and associated availability of the service provider in question, at operations 130 and 140.

At 180, the caller selects an appointment time among the available appointment times. This, again, is done through interactive voice prompt audio presented to the user. The IVR subsystem receives the selected appointment time from the caller, either based on audio spoken by the caller or dial-tone selections made by the caller. Once the caller chooses an appointment time, the IVR subsystem 20 will ask them for their personal details. Using Caller ID functionality, the caller's phone number may already be known to the IVR subsystem. However, the IVR subsystem 20 can prompt the caller for other personal details such as their name and their local zip code. The IVR subsystem 20 is configurable and can be programmed to collect arbitrary pieces of personal data before booking the appointment.

At 190, the IVR subsystem 20 communicates with the availability database subsystem 40 to book the appointment and thereby remove that time slot from available time slots. At 200, the availability database subsystem 40 communicates to the calendar/appointment database subsystem 30 to add the appointment to the calendar for a given service provider.

At 210, the availability database subsystem 40 returns to the IVR subsystem 20 appointment confirmation information, such as an appointment confirmation number. The IVR subsystem 20, at 220, returns the appointment confirmation information, and thereafter hangs up and terminates the call. In one form, the IVR subsystem 20 communicates the appointment confirmation information to the caller by way of audio played out to the caller announcing the appointment confirmation information to the caller. In another form, the IVR subsystem 20 sends a text message to the caller (using the Caller ID), wherein the text message contains the appointment confirmation information for the appointment with the service provider.

Thus, once the appointment is booked, the caller will be informed of a confirmation number to reference their new appointment in the future if a rescheduling or cancellation is required. Once the caller is informed of their confirmation number the telephone session can be terminated or routed elsewhere for further actions to be taken.

The appointment availability presented to the caller is a subset of the service provider's overall “free time” on their calendar system. Computer calendar systems typically only offer the ability to create, move, or cancel appointments, and they do not contain a feature that would allow a service provider to specify the times at which they would like to offer appointments to their customers.

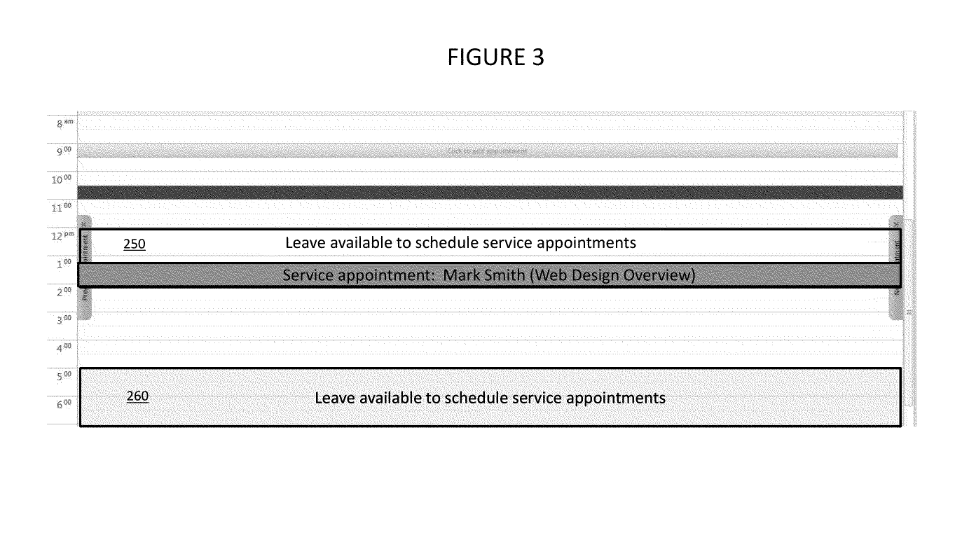

FIG. 3 illustrates a capability in which a service provider can designate certain time windows on that are to be kept available to schedule service appointments for callers (clients). For example, as shown in FIG. 3, at reference numerals 250 and 260, the service provider has designated the time slots 12-2 and 5-6 as time periods when service appointments can automatically be made with callers. Data representing these designated time slots is stored by the calendar subsystem. Moreover, as service appointments are made, the calendar subsystem adjusts the available appointment times accordingly so that time slots do not become double-booked. For example, as shown in FIG. 3, a service appointment is scheduled from 1:00 to 1:30 pm with caller Mark Smith (concerning “web design overview”).

A separate but integrated availability database subsystem can be used to create appointment availability windows that would serve as the basis for such a capability, and the system would be aware of the service provider's calendar to ensure that any calendar-based appointment or meeting would subtract from the service provider's availability and prevent double-booking of the service provider's available times.

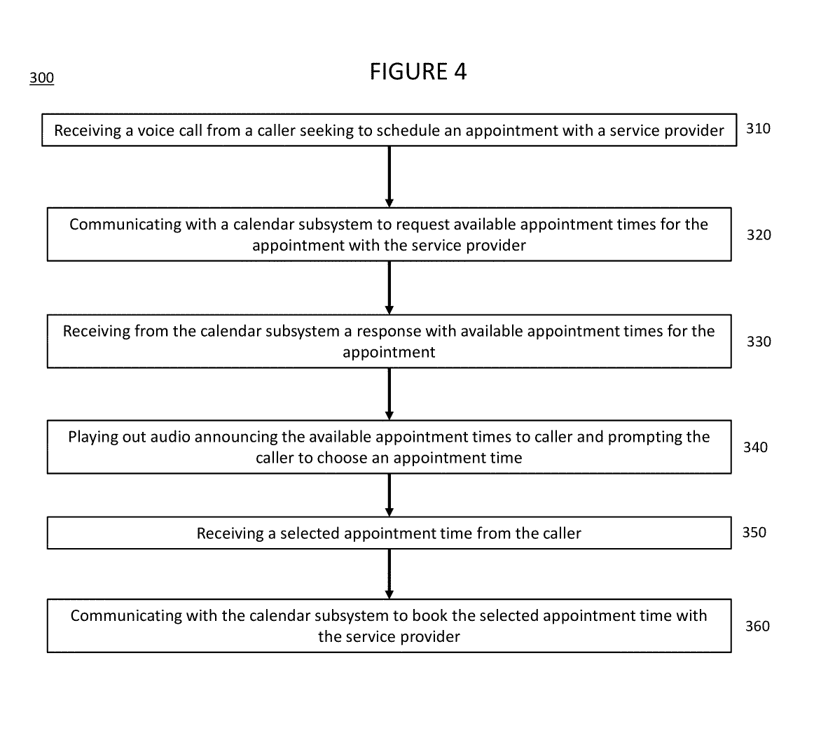

Turning now to FIG. 4, a flow chart is shown for a process 300 performed by the IVR subsystem 20 according to an example embodiment. The method 300 involves, at 310, receiving a voice call from a caller seeking to schedule an appointment with a service provider. At 320, communication is made with a calendar subsystem to request available appointment times for the appointment with the service provider. As explained above, information about the appointment the caller is seeking to make may be automatically derived based on reception of the call (e.g., from a caller ID of the caller) or obtained through IVR interaction with the caller by playing out audio to the caller that prompts the caller to convey information about the appointment and receiving from the caller information about the appointment.

At 330, a response with available appointment times for the appointment is received from the calendar subsystem. At 340, audio is played out that announces the available appointment times to caller and prompting the caller to choose an appointment time. At 350, a selected appointment time is received from the caller. At 360, communication is made with the calendar subsystem to book the selected appointment time with the service provider.

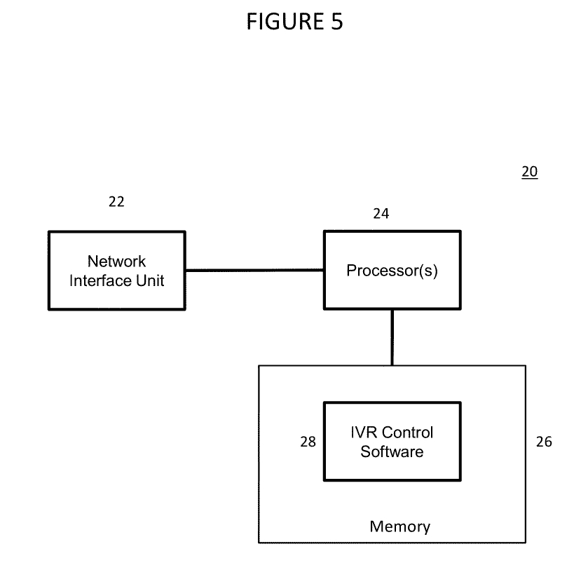

FIG. 5 shows an example block diagram of the IVR Subsystem 20, which includes a network interface unit 22 that interfaces with the telephone network, as well as the other entities shown in FIG. 1, if needed. The IVR Subsystem 20 further includes one or more processors 24 and a memory 26 that stores IVR control software 28. The IVR control software 28 includes instructions that, when executed by the one or more processors, causes the IVR system to perform the operations described above in connection with FIGS. 1-4.

The techniques presented herein may be embodied by software stored in memory, such as read only memory (ROM), random access memory (RAM), magnetic disk storage media devices, optical storage media devices, flash memory devices, electrical, optical, or other physical/tangible memory storage devices. In general, the memory may comprise one or more tangible (non-transitory) computer readable storage media (e.g., a memory device) encoded with software comprising computer executable instructions and when the software is executed (by one or more processors) it is operable to perform the operations described herein.

To summarize, in one form, a method is provided comprising: receiving a voice call from a caller seeking to schedule an appointment with a service provider; playing out audio to the caller prompting to the caller to convey information about the appointment that the caller is seeking to make; receiving from the caller information about the appointment; communicating with a calendar subsystem to request available appointment times for the appointment with the service provider; receiving from the calendar subsystem a response with available appointment times for the appointment; playing out audio announcing the available appointment times to caller and prompting the caller to choose an appointment time; receiving a selected appointment time from the caller; and communicating with the calendar subsystem to book the selected appointment time with the service provider.

In another form, an apparatus is provided comprising: a network interface unit that enables communication with a telephone network and with a calendar subsystem; and a processor coupled to the network interface unit, wherein the processor is configured to: receive a voice call from a caller seeking to schedule an appointment with a service provider; send to the calendar subsystem a request for available appointment times for the appointment with the service provider; receive from the calendar subsystem a response with available appointment times for the appointment; generate and play out audio announcing to the caller the available appointment times and prompting the caller to choose an appointment time; receive a selected appointment time from the caller; and send to the calendar subsystem a message to book the selected appointment time with the service provider.

In still another form, a non-transitory computer readable storage media is provided encoded with instructions that, when executed by a processor, cause the processor to perform operations comprising: receiving a voice call from a caller seeking to schedule an appointment with a service provider; playing out audio to the caller prompting to the caller to convey information about the appointment that the caller is seeking to make; receiving from the caller information about the appointment; communicating with a calendar subsystem to request available appointment times for the appointment with the service provider; receiving from the calendar subsystem a response with available appointment times for the appointment; playing out audio announcing the available appointment times to caller and prompting the caller to choose an appointment time; receiving a selected appointment time from the caller; and communicating with the calendar subsystem to book the selected appointment time with the service provider.

The above description is intended by way of example only. Various modifications and structural changes may be made therein without departing from the scope of the concepts described herein and within the scope and range of equivalents of the claims.

What is claimed is:

1. A method comprising:
receiving a voice call from a caller seeking to schedule an appointment with a service provider;
communicating with a calendar subsystem to request available appointment times for the appointment with the service provider;
receiving from the calendar subsystem a response with available appointment times for the appointment;
playing out audio announcing the available appointment times to caller and prompting the caller to choose an appointment time;
receiving a selected appointment time from the caller; and
communicating with the calendar subsystem to book the selected appointment time with the service provider.

2. The method of claim 1, further comprising determining information about the appointment the caller is seeking to make based on reception of the call from the caller.

3. The method of claim 1, wherein receiving the selected appointment time from the caller comprises receiving voice audio from the caller.

4. The method of claim 1, further comprising receiving from the caller personal data for use in booking the appointment for the service provider.

5. The method of claim 1, further comprising:
playing out audio to the caller prompting the caller to convey information about the appointment that the caller is seeking to make; and
receiving from the caller information about the appointment.

6. The method of claim 5, wherein receiving from the caller the information about the appointment comprises receiving voice audio from the caller.

7. The method of claim 1, further comprising:
receiving an appointment confirmation from the calendar subsystem;
communicating the appointment confirmation to the caller; and
terminating the voice call with the caller.

8. The method of claim 7, wherein communicating the appointment confirmation comprises playing out audio announcing the appointment confirmation to the caller.

9. The method of claim 7, further comprising retrieving a calling line identifier (Caller ID) for the call received from the caller.

10. The method of claim 9, wherein communicating the appointment confirmation comprises sending a text message to a telephone number obtained from the Caller ID of the call from the caller, the text message containing appointment information for the appointment with the service provider.

11. The method of claim 1, wherein the calendar subsystem stores appointment data for a plurality of service providers.

12. The method of claim 1, wherein the available appointment times received from the calendar subsystem include one or more time slots which have designated to remain available for service appointments.

13. The method of claim 12, further comprising receiving from the service provider information for the one or more time slots to be designated to remain available for service appointments.

14. An apparatus comprising:
a network interface unit that enables communication with a telephone network and with a calendar subsystem; and
a processor coupled to the network interface unit, wherein the processor is configured to:
receive a voice call from a caller seeking to schedule an appointment with a service provider;
send to the calendar subsystem a request for available appointment times for the appointment with the service provider;
receive from the calendar subsystem a response with available appointment times for the appointment;
generate and play out audio announcing to the caller the available appointment times and prompting the caller to choose an appointment time;
receive a selected appointment time from the caller; and
send to the calendar subsystem a message to book the selected appointment time with the service provider.

15. The apparatus of claim 14, wherein the processor is further configured to: determine information about the appointment the caller is seeking to make based on reception of the call from the caller.

16. The apparatus of claim 14, wherein the processor is configured to receive the selected appointment time from the caller from voice audio from the caller.

17. The apparatus of claim 14, wherein the processor is configured to receive from the caller personal data for use in booking the appointment for the service provider.

18. The apparatus of claim 14, wherein the processor is further configured to:
generate for play out to the caller audio prompting the caller convey information about the appointment that the caller is seeking to make; and
receive a response from the caller with information about the appointment.

19. The apparatus of claim 18, wherein the processor is configured to receive the information about the appointment in voice audio from the user.

20. The apparatus of claim 14, wherein the processor is further configured to:
receive an appointment confirmation from the calendar subsystem;
communicate the appointment confirmation to the caller; and
terminate the voice call with the caller.

21. The apparatus of claim 20, wherein the processor is configured to communicate the appointment confirmation to the caller by playing out audio announcing the appointment confirmation to the caller.

22. The apparatus of claim 20, wherein the processor is configured to communicate the appointment confirmation to the caller by sending to the caller a text message containing appointment information for the appointment with the service provider.

23. A non-transitory computer readable storage media encoded with instructions that, when executed by a processor, cause the processor to perform operations comprising:
receiving a voice call from a caller seeking to schedule an appointment with a service provider;
communicating with a calendar subsystem to request available appointment times for the appointment with the service provider;
receiving from the calendar subsystem a response with available appointment times for the appointment;
playing out audio announcing the available appointment times to caller and prompting the caller to choose an appointment time;
receiving a selected appointment time from the caller; and
communicating with the calendar subsystem to book the selected appointment time with the service provider.

24. The non-transitory computer readable storage media of claim 23, further comprising instructions operable for:
determining information about the appointment the caller is seeking to make based on reception of the call from the caller.

25. The non-transitory computer readable storage media of claim 23, wherein the instructions operable for receiving the selected appointment time from the caller comprises instructions operable for receiving voice audio from the caller.

26. The non-transitory computer readable storage media of claim 23, further comprising instructions operable for receiving from the caller personal data for use in booking the appointment for the service provider.

27. The non-transitory computer readable storage media of claim 23, further comprising instructions operable for:
playing out audio to the caller prompting the caller to convey information about the appointment that the caller is seeking to make; and
receiving from the caller information about the appointment.

28. The non-transitory computer readable storage media of claim 27, wherein the instructions operable for receiving from the caller information about the appointment comprises instructions for receiving voice audio from the caller.

29. The non-transitory computer readable storage media of claim 27, further comprising instructions operable for:
receiving an appointment confirmation from the calendar subsystem;
communicating the appointment confirmation to the caller; and
terminating the voice call with the caller.

30. The non-transitory computer readable storage media of claim 29, wherein the instructions operable for communicating the appointment confirmation comprises instructions for playing out audio announcing the appointment confirmation to the caller.

31. The non-transitory computer readable storage media of claim 29, wherein the instructions operable for communicating the appointment confirmation comprises instructions operable for sending a text message to the caller, the text message containing appointment information for the appointment with the service provider.
